(19) United States
(12) Patent Application Publication
(10) Pub. No.: US 2013/0050466 A1
(43) Pub. Date: Feb. 28, 2013

(54) METHOD, DEVICE AND SYSTEM FOR DETERMINING THE PRESENCE OF VOLATILE ORGANIC AND HAZARDOUS VAPORS USING AN INFRARED LIGHT SOURCE AND INFRARED VIDEO IMAGING

(71) Applicants: Ahmet Enis Cetin, Ankara (TR); Dennis L. Akers, Sarasota, FL (US)

(72) Inventors: Ahmet Enis Cetin, Ankara (TR); Dennis L. Akers, Sarasota, FL (US)

(21) Appl. No.: 13/581,315

(22) PCT Filed: Feb. 28, 2011
(86) PCT No.: PCT/US2011/026556

§ 371 Date: Nov. 13, 2012

Related U.S. Application Data
(60) Provisional application No. 61/308,783, filed on Feb. 26, 2010.

(51) Int. Cl. H04N 5/33; H04N 7/18

(52) U.S. Cl. 348/82; 348/E07.085

(57) ABSTRACT

An enhanced infrared (IR) imaging based method for detecting volatile organic and hazardous vapors using the infrared spectral absorption properties of these vapors, and using a tunable infrared light source and a plurality of cameras tuned to particular frequency ranges to detect spectral absorption properties corresponding to the respective vapors. Illumination by an IR light source is used to enhance the visibility of vapor plumes in LWIR and MWIR cameras because ambient light may not have enough power in the specific absorption band of the VOC vapor. Plume regions are automatically determined by image and video processing methods by the system. Specific vapors can be detected by using tunable IR light sources because leaking plumes from a damaged component causes dark regions in images of LWIR and/or MWIR cameras depending on the absorption wavelength of the plume.

### BACKGROUND OF THE INVENTION

1. Field of the Invention

The present invention generally relates to the prophylactic detection of impending chemical volatility, and in particular to use of infrared light sources and infrared imaging techniques to detect the presence of volatile organic compounds and other hazardous compound vapors outside a containment system.

2. Background Description

Petroleum refineries and organic chemical manufacturers periodically inspect leaks of volatile organic compounds (VOC) and other hazardous vapors such as ammonia and H₂S from equipment components such as valves, pumps, compressors, flanges, connectors, pump seals, etc. as described in L. Zhou, and Y. Zeng, “Automatic alignment of infrared video VOC frames for equipment leak detection,” Analytica Chimica Acta, Elsevier, v. 584/1, pp. 223-227, 2007. Although Zhou and Zeng mentions the use of IR imaging for VOC detection they fail to mention (i) use of IR light sources to illuminate possible leak areas, and (ii) use of an IR camera to monitor the IR light beam. If the IR light is absorbed it means that there is VOC vapor leakage. If the IR light is scattered or reflected it means that there is no leakage.

Common practice for inspection is to utilize a portable flame ionization detector (FID) sniffing the seal around the components for possible leaks, as indicated by the U.S. Environmental Protection Agency in “Protocol for Equipment Leak Emission Estimates,” EPA-453/R-95-017, November 1995. A single facility typically has hundreds or thousands of such components. FIDs are broadly used for detection of leakage of volatile organic compounds (VOC) in various equipment installed at oil refineries and factories of organic chemicals. For example, U.S. Pat. No. 5,445,795 filed on Nov. 17, 1993 describes “Volatile organic compound sensing devices” used by the United States Army. Another invention by the same inventor, U.S. Patent Application No. 2005/286927, describes a “Volatile organic compound detector.” However, FID based monitoring approaches turns out to be tedious work with high labor costs even if the tests are carried out on as limited a frequency as quarterly. Several optical imaging based methods are proposed in the literature for VOC leak detection as a cost-effective alternative, as described in ENVIRON, 2004: “Development of Emissions Factors and/or Correlation Equations for Gas Leak Detection, and the Development of an EPA Protocol for the Use of a Gas-imaging Device as an Alternative or Supplement to Current Leak Detection and Evaluation Methods,” Final Rep. Texas Council on Env. Tech. and the Texas Comm. on Env. Quality, October, 2004, and M. Lev-On, H. Taback, D. Epperson, J. Siegell, L. Gilmer, and K. Ritterf, “Methods for quantification of mass emissions from leaking process equipment when using optical imaging for leak detection,” Environmental Progress, Wiley, v.25/1, pp. 49-55, 2006. In these approaches, infra-red (IR) cameras operating at a predetermined wavelength band with strong VOC absorptions are used for leak detection. In other contexts it has been shown that fast Fourier transforms can be used to detect the peaks inside a frequency domain.

However, VOC, ammonia and H₂S plumes exhibit variations over time that are random rather than according to a purely sinusoidal frequency. This means that Fourier domain methods are difficult to apply to VOC plume detection. Volatile organic compounds are typically stored in containers and piped through systems using valves, connectors, pump joints, and similar equipment. While this equipment is designed so that the VOC remains contained within the system, there is potential for leakage at these valves, connectors, pump joints and the like. To detect leakage a detector is positioned in the vicinity of such equipment. At these locations, the detector makes separate measurements at each piece of equipment to determine whether or not there is a VOC plume. In the prior art gas leakage in the form of VOC plumes is detected using methods like gas chromatography, as described in Japanese Patent No. JP2006194776 for “Gas Chromotograph System and VOC Measuring Apparatus Using it” to Y. Tarihi, or oxidation as desribed in Patent No. WO2006087683 for “Breath Test for Total Organic Carbon”. However, these processes cause loss of time, effort and money at places, such as oil refineries, where there are many pieces of equipment that are likely to incur leakage. Therefore there is a need for a VOC plume detection technology that is not constrained by the foregoing limitations of the prior art.

### SUMMARY OF THE INVENTION

The present invention is a VOC plume detection method and system based on the use of an IR light source and IR imaging. A system using the invention provides a more sensitive alternative to flame ionization detectors which are currently in use to detect VOC leakages from damaged equipment components in petrochemical refineries. Possible leak areas are illuminated by an IR light source and an IR camera or cameras capturing the video of the light beam as shown in FIG. 1.

The invention provides an enhanced infrared (IR) imaging based method for detecting volatile organic and hazardous vapors using the infrared spectral absorption properties of these vapors, and using a tunable infrared light source and a plurality of cameras tuned to particular frequency ranges to detect spectral absorption properties corresponding to the respective vapors. Illumination by an IR light source is used to enhance the visibility of vapor plumes in LWIR and MWIR cameras because ambient light may not have enough power in the specific absorption band of the vapor plumes. Plume regions are automatically determined by image and video processing methods by the system. Specific vapors can be detected by using tunable IR light sources because leaking plumes from a damaged component causes dark regions in images of LWIR and/or MWIR cameras depending on the absorption wavelength of the plume. Shining IR light tuned to the absorption frequency of the plume vapor significantly increases corresponding regions in LWIR and MWIR camera image frames, and the same image region becomes darker in an IR camera when the wavelength of the light source is moved away from the absorption frequency.

The present invention uses and IR light source 100 and one or more IR cameras 200. A typical Long Wave IR (LWIR) camera covering 8 to 12 micrometers and a Mid Wave IR (MWIR) covering 3 to 5 micrometers are used to monitor possible VOC gas leak areas. Some LWIR cameras cover a wider band of wavelengths from 7 to 15 micrometers. These LWIR and MWIR cameras are commonly available in the market. There are also wide band IR cameras covering both MWIR and LWIR bands at the same time.

VOC and other hazardous gas vapors have unique absorption bands. Some of the gas vapors absorb IR energy only in the LWIR band and some of them absorb only in the MWIR band etc. For example, methane absorbs light only in MWIR band, whereas propane vapor absorbs light in visible and LWIR bands. Therefore we can shine IR light on the absorption frequency of the gas vapor to possible leak locations. If this light is absorbed it will appear as a dark spot in an IR camera imaging the monitored location. Furthermore, we can distinguish the nature of the VOC vapor by comparing the LWIR and MWIR images at the same time.

None of the above inventions and public domain documents mention the use of IR light sources and LWIR and MWIR camera images at the same time to detect VOC gas leaks.

The method of the invention processes sequences of image frames (“video image data”) captured by infrared cameras. The method and system of the invention automatically determines if the light beam is absorbed or scattered or reflected. Several embodiments of the invention are described herein. One embodiment uses image processing methods to determine the reaction to the IR light beam. When the beam is absorbed by the VOC gas it appears as a dark spot in the IR video. When it is reflected from the background it will appear as a bright spot or a scattered bright region when it is scattered from the background.

The invention discloses a method and system for determining the presence of volatile organic compounds (VOC) and other hazardous vapors using video image data to detect a gray scale value decrease at a leakage site by analyzing the video image data. Moving bright regions corresponding to the light beam in a current video image are detected, and then it is determined whether the detected moving region in time has decreased pixel values or not.

In one aspect, the invention provides an enhanced imaging capability for IR cameras by the use of an IR light source. When there is a VOC leak the VOC vapor absorbs the IR light in the environment and it may be observable by an IR camera. By shining IR light we increase the amount of light and this increases the detection performance of the IR camera. The present invention has a multi-channel (MWIR, and LWIR channels) infrared video processing capability. In another aspect, the invention may compare the image frames of MWIR and LWIR cameras to estimate the nature of the VOC gas leak.

In another aspect, the invention utilizes a moving object tracker to determine the light beam in infrared video. Commonly used object trackers include mean-shift tracker and covariance trackers. Cetin et al. recently developed a co-difference tracker to track moving objects in video. If there is VOC leakage the detected moving region will become darker and the pixel values will be lower than surrounding image region. This is an indicator of VOC leakage in the monitored area.

A further aspect of the invention is to determine if the decreased pixel valued region flickers over time or not. This is achieved by using a three-state hidden Markov model to determine flicker for the detected moving region by analyzing the pixel values of a region in image frames of the IR video, and selecting for the detected moving region a model having the highest value of probability of transition between states of VOC and non-VOC Markov models.

This three-state hidden Markov model technique is an improvement upon the public domain fire detection method described in “Fire detection in infrared video using wavelet analysis”, by B. U. Toreyin, R. G. Cinbis, Y. Dedeo\check{u}lu, and A. E. Cetin published in Optical Engineering, 2007. LWIR and MWIR cameras cannot detect regular smoke. If an ordinary moving object such as a person, an animal, or a vehicle passes in front of the system its image will appear in both MWIR and LWIR and visible range cameras. This is not possible for a VOC or H₂S and ammonia plume. Ordinary moving objects will not absorb IR illumination, they will reflect it or scatter it.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic showing operation of the invention with an IR light source 100 and an IR camera 200.

FIG. 2 is the absorption spectra of ethane (adopted from National Institute of Standards and Technology (NIST)).

FIG. 3 is the absorption spectra of methane (adopted from NIST).

FIG. 4 is the absorption spectra of propane (adopted from NIST).

FIG. 5 is the absorption spectra of ammonia (adopted from NIST).

FIG. 6 is the absorption spectra of H₂S (adopted from NIST).

FIG. 7 is a schematic showing various IR cameras monitoring a possible VOC leakage area.

### DETAILED DESCRIPTION OF A PREFERRED EMBODIMENT OF THE INVENTION

The present invention is an innovative device and system developed for detecting plumes of volatile organic compounds (VOC) in a plurality of images captured using infrared cameras and light sources.

There are different types of fugitive VOC emissions with varying plume characteristics. For example, diesel and propane have vapor similar to smoke coming out of a pile of burning wood whereas gasoline vapor, ethane, methane, ammonia, and the poisonous chemical H₂S vapors are transparent. They cannot be visualized in visible range videos. However, all of the vapors have flickering or turbulent plumes.

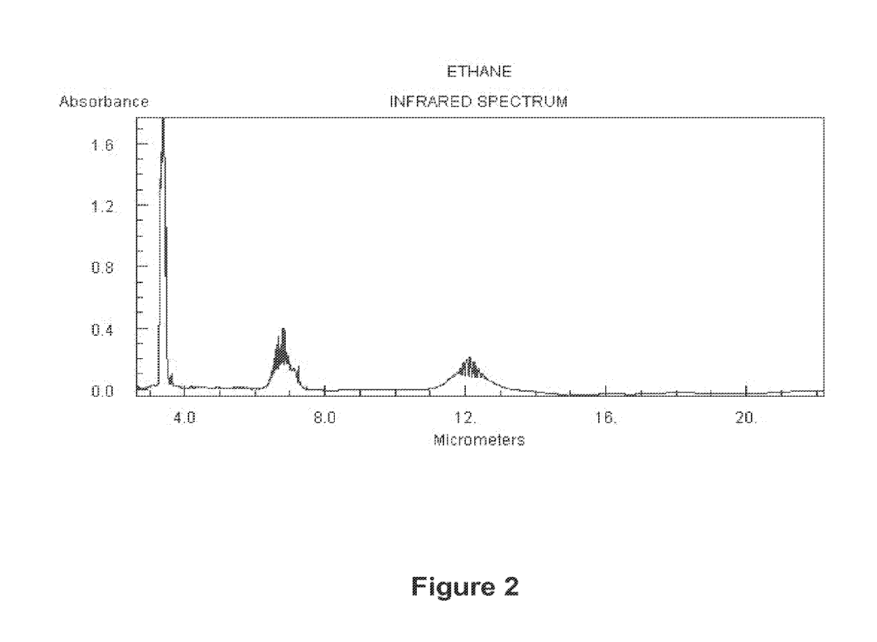

As is pointed in the article “Automatic alignment of infrared video frames for equipment leak detection,” by L. Zhou, and Y. Zeng, Analytica Chimica Acta, Elsevier, v. 584/1, pp. 223-227, 2007, the temperature of the VOC plume emitted from a leaking component drops during the initial expansion due to the absorption of IR energy of the background by the chemical. This causes a temperature difference between the VOC plume and the surrounding air. Each gas has specific IR absorption frequencies as shown in FIGS. 2 to 6. Therefore an infrared camera whose range covers one of the absorption frequencies of a VOC vapor can produce an image of the VOC plume in spite of the fact that the vapor is invisible to the naked eye.

However there may not be enough ambient IR light especially at night or there may be other cold objects in the monitored area. It is possible to increase the visibility of the VOC vapor in IR video by shining IR light beam on the possible leakage areas because the leaking gas absorbs the external light and this causes a decrease in pixel values in the IR video. Especially at night ambient IR light levels are low. The use of an IR light source to increase the ambient light level will increase the visibility of VOC vapor. The IR light source can be a tunable IR laser or an IR blackbody emitter.

It is not possible to visualize a VOC vapor whose absorption frequency is in the medium wave IR (MWIR) band with an infrared camera capable of imaging only the Long Wave IR (LWIR) band.

Independent of the VOC type, plumes emitted from leaking components modify the background in image frames of the video. In IR videos VOC vapor or H₂S and ammonia vapors decrease the values of pixels in a region of the image in white-hot mode infrared (IR) camera, and an increased value in a region in the black-hot mode IR camera. There are other color mapping schemes in IR cameras such as hot regions are marked red and cold regions are marked blue etc. In general, IR video pixels are single valued numbers and most cameras map pixel values between 0 and 255. In white (black) hot mode, pixel value 255 (0) corresponds to white and 0 (255) corresponds to black. In the rest of this disclosure we assume that the IR camera is in white-hot mode.

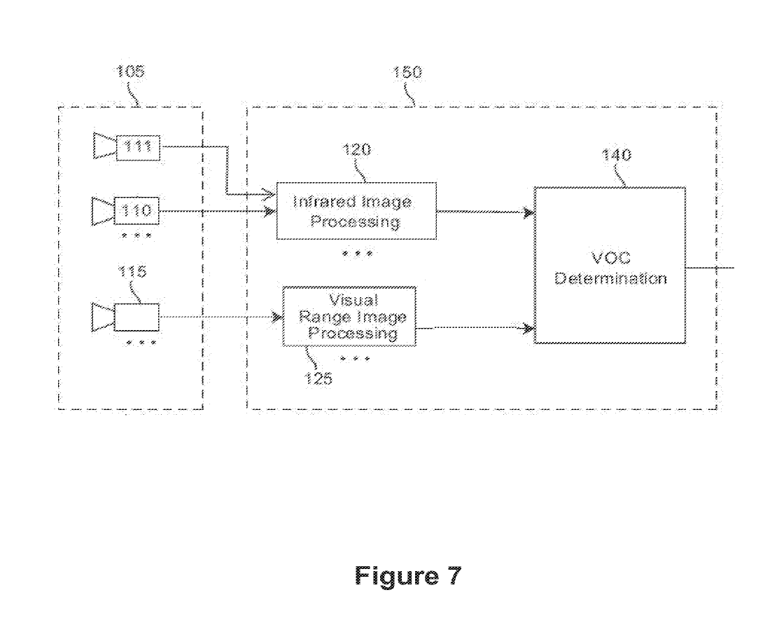

Referring now to the drawings, and more particularly to FIG. 7, there is shown in schematic form operation of a VOC detection device in accordance with the invention. In the baseline VOC detection system shown in FIG. 7, MWIR, LWIR8 whose coverage starts at 8 micrometers, and visible range cameras are used. In more advanced systems an additional LWIR camera with a wider coverage (starting at 7 micrometers) is available. The infrared cameras (IR) 110, 111 generate a plurality of images, which are analyzed 120.

Similarly, visible range camera 115 generates a plurality of images, which are also analyzed but the IR light beam cannot be observed in the visible light camera. With the use of a blackbody IR light source the imaging capability of IR cameras will be increased. Infrared cameras can monitor different bands of the infrared spectrum to detect the nature of the VOC leak. Similarly, IR light sources with different frequency bandwidths can be used to illuminate different parts of the infrared spectrum. The imaging results from both the infrared and the visible cameras are used to make a decision 140 whether or not VOC and H₂S and ammonia plumes are present at a location corresponding to the images. The invention may be configured with a plurality of sensors 105, and implementation on a computer 150 will typically provide for multiple instances of VOC analysis (120,125). Determinations 140 will be applied to possible VOC detections at multiple physical locations covered by the images generated by the cameras (110,115).

### Adaptive Plume Detection

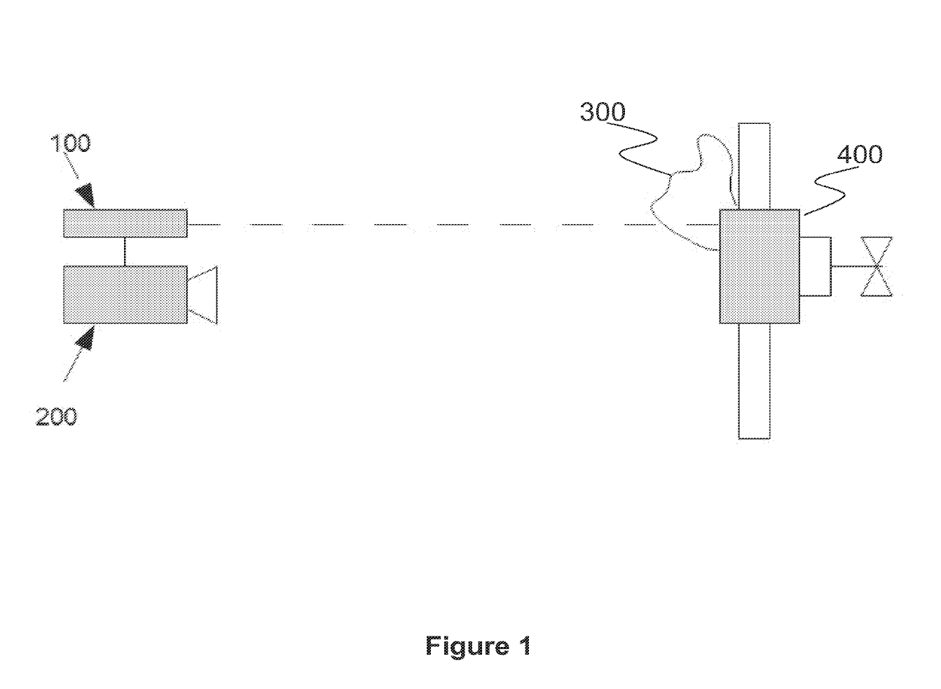

The first step in this embodiment of the VOC plume detection method, where a plume 300 escapes from a leak in a valve assembly 400, is to detect changing regions due to the IR light source 100 in infrared video captured by the camera 200 in FIG. 1. Moving object/region detection is a common method in many video processing systems. The next step involves tracking of moving region corresponding to the IR light beam. In this application we use the co-difference method based object tracking. Co-difference method is explained in the public domain document “Image Description Using a Multiplier-Less Operator,” by Tuna, Hakan; Onaran, Ibrahim and Cetin, A. Enis published in IEEE Signal Processing Letters, vol. 16, issue 9, pp. 751-753 in 2009. In this method the light beam region in the current image frame is compared with the corresponding region in the next image frame of the IR video by using the co-difference operator. In this way the light beam is tracked in video. Whenever the pixel values of the light beam decreases unusually in the IR video then this corresponds to IR light absorption and it is an indication of existence of VOC vapors in the scene. This segment of the scene is classified as a candidate plume region by the decision algorithm of the VOC detection system.

Candidate plume regions are further analyzed to check if they have a turbulent behavior. It is verified if the average value of the candidate region over time displays any Markovian random behavior using Markov models. Since plume changes its shape over time average pixel value of the candidate region changes over time and this change is not deterministic but stochastic. Markov model based analysis of the plume region detection can be carried out as described in public domain documents by Cetin et al. entitled “Contour based smoke detection in video using wavelets”, and “Real time fire and flame detection in video”. As a result a moving region in the video can be classified as a candidate plume region or not. Once all the candidate plume regions are detected they can be further analyzed for a final decision using the additional information coming from tunable IR laser light source or an IR blackbody emitter.

### MWIR and LWIR Imaging for Vapor Leak Estimation

Although they image the same scene LWIR and MWIR cameras provide different intensity values for each pixel because they monitor different IR bands. A plume region can be detected in an LWIR camera but it may not be detected in the MWIR camera (or vice versa) depending on the VOC compound. In the baseline VOC detection system shown in FIG. 7 MWIR, LWIR8 whose coverage starts at 8 micrometers and a visible range camera are used. In more advanced systems an additional LWIR camera with a wider coverage (starting at 7 micrometers) is available. Next, we present the detection method that we use to estimate typical chemicals in a refinery.

Ethane (C₂H₆) Detection:

Ethane has a strong absorption peak around 3.5 micrometers and small peaks around 6.7 and 12 micrometers as shown in FIG. 2 adopted from (http://webbook.nist.gov/chemistry/form-ser.html). Therefore, an MWIR camera can detect the ethane leak but an LWIR camera may or may not detect the leak depending on the concentration. In a typical case, the MWIR video channel would detect the leakage plume but the LWIR camera will not detect any change in video pixels. When a blackbody IR light source in the LWIR band emits light on the Ethane plume the LWIR camera may also produce a semi-transparent image of the plume. If an IR laser light at 3.5 micrometer is available VOC plume will absorb this light and the tracked region in video will be darker. When the tunable IR laser light moves to 4 micrometer this light will not be absorbed and we will not see any darkening of the candidate region. Similarly, when the IR source emits light at 12 micrometer it will be absorbed and when it emits light at 13 micrometers we will not see any change in pixel values in the IR video generated by the LWIR camera.

Methane (CH₄) Detection:

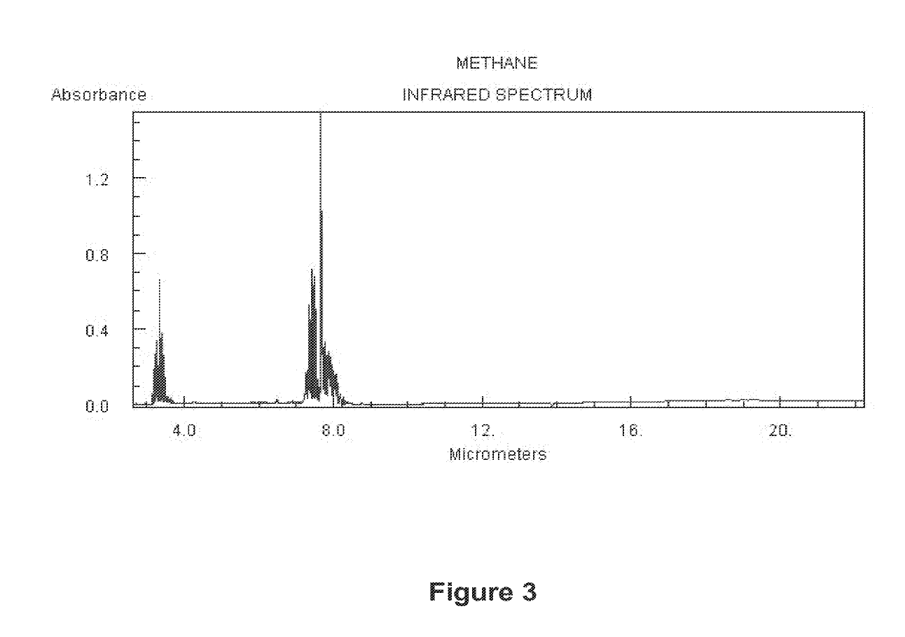

Methane has a strong absorption peak around 7.5 micrometers and a small peak at 3.5 micrometers as shown in FIG. 3 adopted from the NIST web site. Therefore, it is true both that an LWIR camera covering 7 to 14 micrometers can detect the methane leak but an LWIR camera with a 8 to 14 micrometers range cannot detect the leak, depending on the concentration. An MWIR camera can also detect the plume but not as strong as the LWIR camera. For methane detection it is best to use three IR cameras. However, an LWIR camera with a range starting at 7 microns (LWIR7) and an MWIR camera also may determine the existence of methane. When the tunable light source emits light at 7.5 micrometers we will see the effect in the LWIR7 camera. On the other hand when the source emits light above 7.5 microns we do not see any change in the LWIR7 camera images. Therefore it is possible to distinguish Methane using a tunable IR light source covering the 7 to 12 micron LWIR band. If a blackbody IR source illuminates the candidate region both the MWIR and LWIR cameras will observe darker plume regions compared to no-IR-light case.

Propane (C₃H₈) Detection:

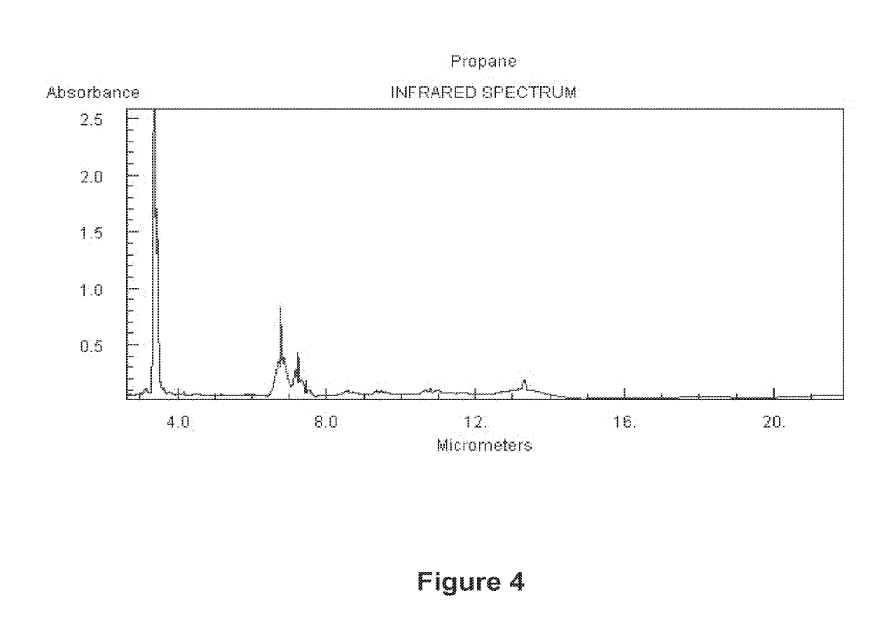

Absorption spectra of propane is shown in FIG. 4. Propane is visible by a visible range camera. If a plume region is detected by both the regular camera and the MWIR camera it is a propane. When the IR source emitting in MWIR range is available then it will increase the visibility of the propane plume in the MWIR video. One can even include a visible range camera (125) to the system to detect propane because we can see propane vapor using an ordinary camera.

Ammonia and H₂S are two hazardous vapors that can leak in refineries.

Ammonia (NH₄) Detection:

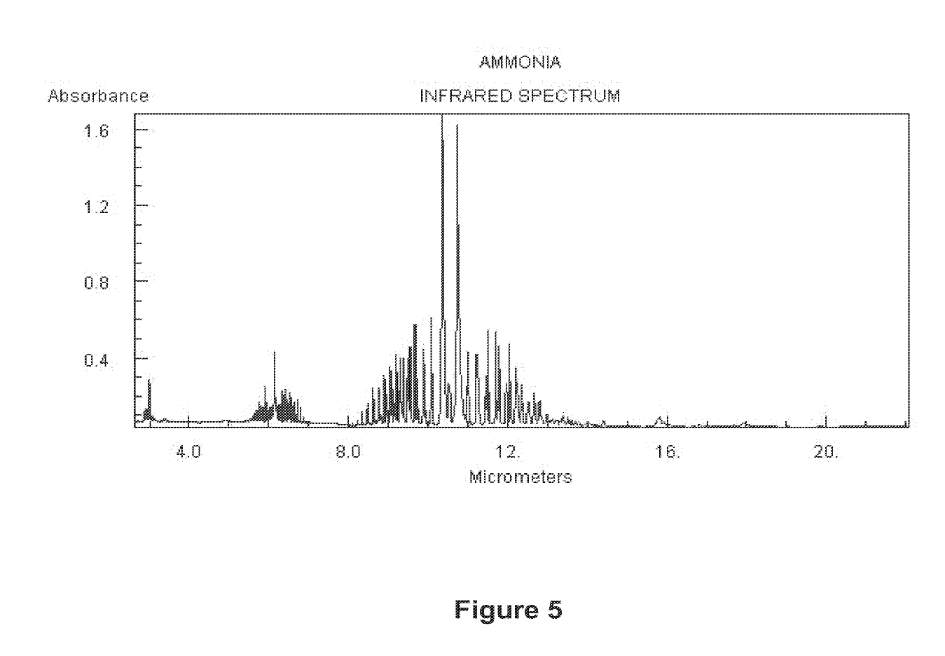

Absorption spectra of ammonia vapor is shown in FIG. 5. Ammonia leak can be detected by an LWIR camera but it cannot be detected by MWIR cameras. Therefore a blackbody source covering the LWIR band will increase the visibility of the ammonia plume. By tuning an LWIR laser source to the ammonia peak it is possible to distinguish ammonia from the other VOC vapors as described above. For example, we will not see any effect of the tunable IR source on the LWIR camera images above 13 micrometers because ammonia has no absorption peaks above 13 micrometers.

H₂S Detection:

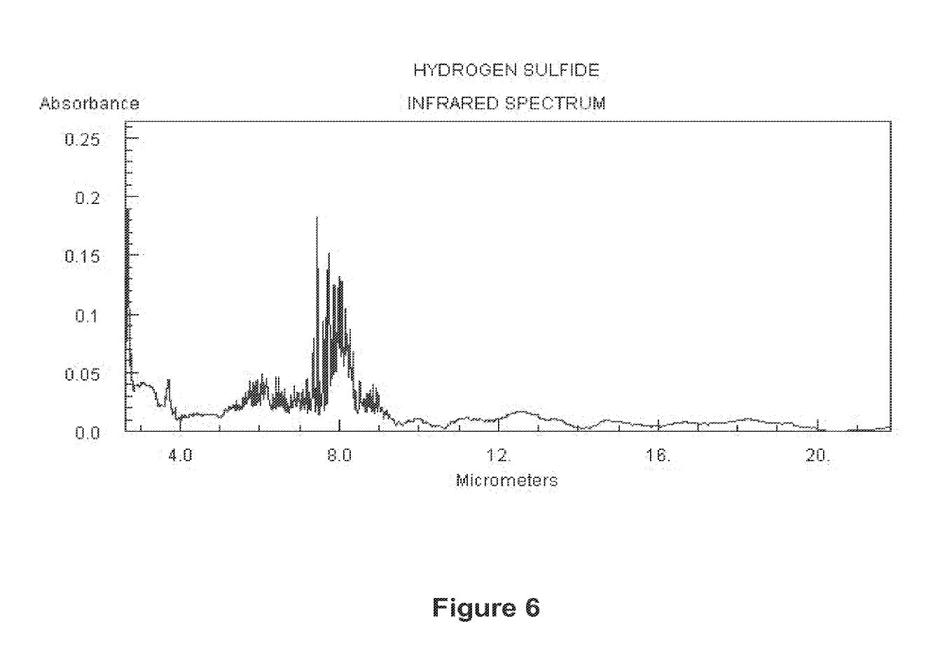

Absorption spectra of poisonous H₂S vapor is shown in FIG. 6. It has two small absorption peaks at 7 and 8 micrometers. H₂S absorbs less IR light compared to VOC compounds. It would be better to use two LWIR cameras with ranges starting from 7 and 8 microns, respectively. Blackbody IR light source will not provide any new information in the MWIR camera because H₂S does not absorb any IR light in the MWIR band. On the other hand it will improve the visibility of H₂S in LWIR cameras. It is possible to detect H₂S using a tunable IR light source. When the source emits light at 7 or 8 microns the H₂S plume region will get darker in image frames of the LWIR camera video. Between 7 and 8 microns or above 8 microns, we will not observe any change in the LWIR video image frames because the H₂S vapor plume will not absorb any IR light in these wavelengths.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for determining the presence of volatile organic and hazardous vapors, comprising:
applying a tunable infrared light source to a subject area; and
detecting absorption spectra in the subject area, said detection being enhanced by the tunable infrared light source.

2. The method of claim 1, wherein detecting absorption spectra further comprises:
using one or more cameras having sensitivity ranges overlapping absorption spectra of a vapor plume; and
automatically determining plume regions by image processing of output from the cameras.

3. The method of claim 2, wherein the tunable infrared light source is tuned to the absorption frequency of the vapor plume.

4. The method of claim 2, wherein detecting absorption spectra further comprises:
detecting a moving object region; and
tracking the moving object region corresponding to the light beam of the tunable infrared light source.

5. The method of claim 4, wherein said tracking is accomplished by a co-difference method.

6. The method of claim 2, wherein the cameras include an MWIR camera, an LWIR camera and an optical camera, wherein the tunable light source emits blackbody IR radiation.

7. The method of claim 2, wherein the cameras include an MWIR camera and an LWIR7 camera, and wherein the tunable light source is applied over the range 7 to 12 microns.

8. The method of claim 2, wherein the cameras include an MWIR camera and an LWIR camera, and wherein the tunable light source is tuned to an absorption spectrum peak of a vapor plume.

9. An apparatus for determining the presence of volatile organic and hazardous vapors, comprising:
a tunable infrared light source for application to a subject area; and
means for detecting absorption spectra in the subject area, said detection being enhanced by the tunable infrared light source.

10. The apparatus of claim 9, wherein the means for detecting absorption spectra further comprises:
one or more cameras having sensitivity ranges overlapping absorption spectra of a vapor plume; and
means for automatically determining plume regions by image processing of output from the cameras.

11. The apparatus of claim 10, wherein the tunable infrared light source is tuned to the absorption frequency of the vapor plume.

12. The apparatus of claim 10, wherein the means for detecting absorption spectra further comprises:
means for detecting a moving object region; and
means for tracking the moving object region corresponding to the light beam of the tunable infrared light source.

13. The apparatus of claim 12, wherein said tracking means uses a co-difference method.

14. The apparatus of claim 10, wherein the cameras include an MWIR camera, an LWIR camera and an optical camera, wherein the tunable light source emits blackbody IR radiation.

15. The apparatus of claim 10, wherein the cameras include an MWIR camera and an LWIR7 camera, and wherein the tunable light source is applied over the range 7 to 12 microns.

16. The apparatus of claim 10, wherein the cameras include an MWIR camera and an LWIR camera, and wherein the tunable light source is tuned to an absorption spectrum peak of a vapor plume.
